(19) United States
(12) Patent Application Publication
(10) Pub. No.: US 2015/0142563 A1
(43) Pub. Date: May 21, 2015

(54) System and Method for Targeted Delivery of Digital Information

(71) Applicants: David M. Diamond, New York, NY (US); Sheldon H. Smith, Toronto (CA); Kathi Kim-Ellen Hurst, Toronto (CA)

(72) Inventors: David M. Diamond, New York, NY (US); Sheldon H. Smith, Toronto (CA); Kathi Kim-Ellen Hurst, Toronto (CA)

(73) Assignee: Twenty-Ten, Inc., Toronto (CA)

(21) Appl. No.: 14/549,969

(22) Filed: Nov. 21, 2014

Related U.S. Application Data
(60) Provisional application No. 61/906,993, filed on Nov. 21, 2013.

(51) Int. Cl. G06Q 30/02

(52) U.S. Cl. CPC G06Q 30/0255
USPC 705/14.53

(57) ABSTRACT

A system. The system includes a computing device, a cookie pool module and an instruction module. The computing device includes a processor. The cookie pool module is communicably connected to the processor and is configured to receive cookie pool data and utilize the received cookie pool data to associate a targeted consumer with a corresponding digital device. The instruction module is communicably connected to the processor and is configured to send an instruction to have digital information sent to the digital device.

### CROSS-REFERENCE TO RELATED APPLICATION

This application claims the benefit under 35 U.S.C. §119(e) of the earlier filing date of U.S. Provisional Patent Application No. 61/906,993 filed on Nov. 21, 2013, the content of which is hereby incorporated in its entirety.

### BACKGROUND

This application discloses an invention which is related, generally and in various embodiments, to a system and method for targeted delivery of digital information.

In the 19th century, a leading marketer commented that he knew that half of his advertising was wasted, he just did not know which half. For the last 130 years, marketers have been trying to address this issue via targeting. One way to target is to identify consumers who share specific attitudes and personalities and reach only those consumers with advertising customized to match their concerns and needs. Examples of identifying consumers at least in part in such a manner are described, for example, in U.S. Pat. Nos. 7,472,072 and 7,835,940, as well as U.S. patent application Ser. Nos. 12/869,441, 13/020,967, 13/167,899 and 13/298,324, each of which are owned by the Assignee of the instant application and the contents of which are hereby incorporated by reference in their entireties. However, the majority of such targeted advertising has been via “mass” distribution such as mailings, print ads, television ads, radio ads, etc.

Digital advertising represents a new way to reach consumers, and advertisers are spending an increasing percentage of their media dollars on digital media. With the explosion of the use of digital devices by potential consumers, displaying advertising on such devices offers advertisers a unique way to reach such consumers. However, even though the advertisers are spending more of their media dollars on digital media, the advertisers are typically unable to quantify whether or not the digital display advertising is working as intended. In general, the advertisers are not sure if they are reaching the right consumers with the right messages and thus are not really sure what they are getting for their money.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1; and

FIG. 3 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

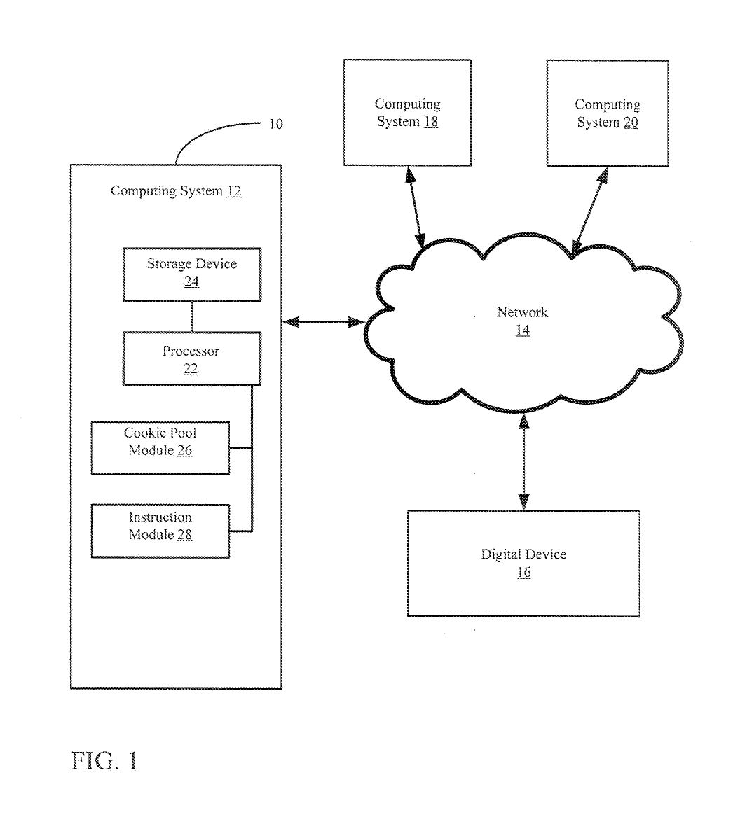

FIG. 1 illustrates various embodiments of a system 10. The system 10 includes a computing system 12 which is communicably connected to a network 14, which is also communicably connected to a digital device 16, a computing system 18 and a computing system 20. As each of the computing systems 12, 18, 20 are communicably connected to the network 14, it will be appreciated that the computing system 12 may be communicably connected to the computing systems 18, 20. Similarly, the computer systems 18, 20 may be communicably connected to the digital device 16. Although only one network 14, one digital device 16, one computing system 18 and one computing system 20 are shown in FIG. 1 for purposes of simplicity, it will be appreciated that the computing system 12 may be communicably connected to any number of networks 14 which in turn are communicably connected to any number of digital devices 16 (e.g., thousands, hundreds of thousands, millions, etc.), computer systems 18 and computer systems 20.

As explained in more detail hereinbelow, the system 10 may be utilized to have digital information automatically sent to digital devices 16 associated with targeted consumers who have been attitudinally segmented (segmented based on expressed attitudes) or attitudinally and behaviorally segmented (segmented based on a combination of (1) expressed attitudes and (2) past behavior and/or expressed future predispositions to take certain actions). The digital information may be any suitable type of information. For example, according to various embodiments, the digital information can be site content, advertisements, technical capabilities, etc. By segmenting digital media to consumers based on attitudinal grouping or a combination of attitudinal and behavioral grouping, the digital information can be more effectively directed to the consumers who are most likely to take the desired follow-up actions. For purposes of simplicity, the digital information will be described hereinafter in the context of advertisements. However, it will be appreciated that digital information can be information other than advertisements.

The computing system 12 may include any suitable type of computing device (e.g., a server, a desktop, a laptop, etc.) that includes at least one processor 22. In general, the computing system 12 is configured to assign prospective consumers into specific attitudinal segments or into specific combinations of attitudinal and behavioral segments, and identify target consumers based on the attitudinal segments or on the specific combinations of attitudinal and behavioral segments. According to various embodiments, the computing system 12 is configured similarly to the targeting engines disclosed in U.S. Pat. Nos. 7,472,072 and 7,835,940, as well as those disclosed in U.S. patent application Ser. Nos. 12/869,441, 13/020,967, 13/167,899 and 13/298,324, each of which are owned by the Assignee of the instant application and the contents of which are hereby incorporated by reference in their entireties. Additionally, as shown in FIG. 1, according to various embodiments, the computing system 12 may also include a storage device 24, a cookie pool module 26 and an instruction module 28.

The storage device 24 is communicably connected to the processor 22 and may be any suitable type of storage device. The cookie pool module 26 is communicably connected to the processor 22 and is configured to receive cookie pool data from computing system 18 and utilize the cookie pool data to associate specific digital devices 16 with specific target consumers. The instruction module 28 is communicably connected to the processor 22 and is configured to send instructions (e.g., advertising instructions) to computing system 20 to have digital information (e.g., an advertisement) be sent to the digital devices 16. For purposes of simplicity, various aspects of the computing system 12 which are common to those found in the targeting engines disclosed in U.S. Pat. Nos. 7,472,072 and 7,835,940, as well as those disclosed in U.S. patent application Ser. Nos. 12/869,441, 13/020,967, 13/167,899 and 13/298,324 are not necessarily shown in FIG. 1. However, it will be appreciated that such aspects may be included in the computing system 12.

According to various embodiments, one or more modules (e.g., the cookie pool module 26, the instruction module 28, etc.) may be utilized to realize the functionality of the computing system 12. The modules may be implemented in hardware, firmware, software and combinations thereof. For embodiments utilizing software, the software may utilize any suitable computer language (e.g., C, C++, Java, JavaScript, Visual Basic, VBScript, Delphi) and may he embodied permanently or temporarily in any type of machine, component, physical or virtual equipment, storage medium, or propagated signal capable of delivering instructions to a device. The modules (e.g., software application, computer program) may be stored on a computer-readable medium (e.g., disk, device, and/or propagated signal) such that when a computer reads the medium, the functions described herein are performed.

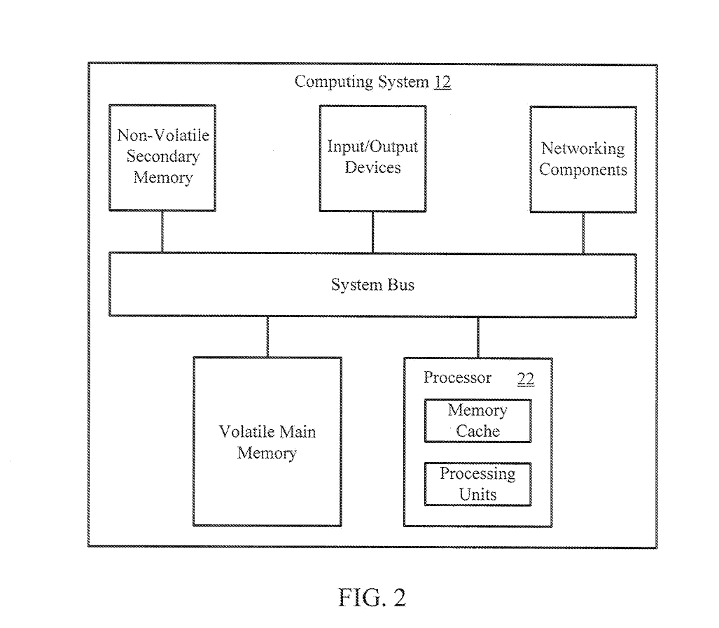

According to various embodiments, the computing system 12 includes a plurality of modules. According to some embodiments, the functionality of two or more of the modules may be combined into a single module. For embodiments where the computing system 12 includes more than one computing device, the modules may be distributed across two or more of the computing devices. Various embodiments of the computing system 12 are described in more detail hereinbelow with respect to FIG. 2.

The network 14 may include one or more networks, and each network may include any type of delivery system including, but not limited to, a local area network (e.g., Ethernet), a wide area network (e.g. the Internet and/or World Wide Web), a telephone network (e.g., analog, digital, wired, wireless, fiber optic, PSTN, ISDN, GSM, GPRS, and/or xDSL), a packet-switched network, a radio network, a television network, a cable network, a satellite network, and/or any other wired or wireless communications network configured to carry data. A given network 14 may include elements, such as, for example, intermediate nodes, proxy servers, routers, switches, and adapters configured to direct and/or deliver data. In general, the system 10 may be structured and arranged to communicate with the digital devices 16 and the computing systems 18, 20 via the one or more networks 14 using various communication protocols (e.g., HTTP, HTTPS, TCP/IP, UDP, WAP, WiFi, Bluetooth) and/or to operate within or in concert with one or more other communications systems.

The digital device 16 may be any type of digital device (e.g., desktop computer, laptop computer, notebook, notepad, personal digital assistant, smart phone, etc. having a display screen) and each digital device 16 is generally associated with a particular consumer and/or household. As a given digital device 16 is used to access various websites, cookies (small bits of text) can be downloaded from the various websites to the browser of the digital device 16. The cookies carry bits of useful information about your interaction with the website that sends them. Although the cookies generally do not contain any information that would identify a person using the digital device 16, they can be utilized to help determine the person and/or household associated with the digital device 16.

The computing system 18 may include any suitable type of computing device. For example, according to various embodiments, the computing system 18 may include one or more servers, desktops, laptops, etc. which can be communicably connected to the network 14. The entity associated with the computing system 18 may utilize the computing system 18 to gather and store cookie pool data (e.g., a set of cookies that the entity considers to be active and targetable) associated with any number of the digital devices 16, and transmit the cookie pool data to the computing system 12 via the network 14. According to various embodiments, the computing system 12 may receive the cookie pool data in a manner other than via the network 14. For example, the cookie pool data may be stored on a memory device which is mailed, hand-delivered, etc. for input into the computing system 12.

The computing system 20 may include any suitable type of computing device. For example, according to various embodiments, the computing system 20 may include one or more servers, desktops, laptops, etc. which can be communicably connected to the network 14. The entity associated with the computing system 20 (e.g., Yahoo) may utilize the computing system 20 to receive instructions (e.g., advertising instructions) from the computing system 12 (e.g., send this advertisement to this digital device for display thereon any time the digital device accesses this website), and transmit the digital advertising in accordance with the instructions to the digital device 16 for display thereon.

FIG. 2 illustrates various embodiments of the computing system 12. The computing system 12 may be embodied as one or more computing devices, and includes networking components such as Ethernet adapters, non-volatile secondary memory such as magnetic disks, input/output devices such as keyboards and visual displays, volatile main memory, and a processor 22. Each of these components may be communicably connected via a common system bus. The processor 22 includes processing units and on-chip storage devices such as memory caches.

According to various embodiments, the computing system 12 includes one or more modules which are implemented in software, and the software is stored in non-volatile memory devices while not in use. When the software is needed, the software is loaded into volatile main memory. After the software is loaded into volatile main memory, the processor 22 reads software instructions from volatile main memory and performs useful operations by executing sequences of the software instructions on data which is read into the processor 22 from volatile main memory. Upon completion of the useful operations, the processor 22 writes certain data results to volatile main memory.

Returning to FIG. 1, at a high level, according to various embodiments, the system 10 is utilized to identify target consumers by attitudinal segment or by a combination of attitudinal and behavioral segments. then connect those consumers to specific cookies using certain data (e.g., Experian data). When those cookies are identified, the system 10 is able to communicate highly targeted digital information (e.g., certain content, advertisements, technical capabilities, etc.) to those consumers (and/or the household associated with the consumer) across a wide variety of digital environments, via third-parties such as, for example, Experian, AddThis, Peer 39, etc. It is understood that the available cookie pools may be aggregated to maximize the number of targeted impressions delivered to the digital devices of the consumers and/or households associated with the consumers.

Conceptually, by replacing postal addresses with user-specific cookies, digital media (e.g., advertisements) can be viewed like direct mail. However, unlike traditional media, the system 10 is utilized to (1) develop sets of specific consumers who belong to specific attitudinal groups or to specific combinations of attitudinal and behavioral groups and (2) reach these consumers and/or their households through cookies tied to specific digital devices 16. By linking pools of cookies with individual computer users (the consumers and/or household members) and by then linking those users to pre-determined attitudinal segments or to pre-determined combinations of attitudinal and behavioral segments, the system 10 is able to deliver exactly the right digital information (e.g., advertisements) to exactly the right consumers. As explained hereinabove, the system 10 may also be utilized to target a variety of other specific types of medium such as, for example, site content, ad placement, technical capabilities, etc.

In operation, for embodiments where the consumers are grouped into attitudinal segments, an attitudinal survey is completed. A significant number of consumers are asked about a product or category being marketed. The survey results are then analyzed, and the respondents are grouped into a set of attitudinal segments (e.g. 4-8 attitudinal segments), with each segment representing a specific and distinct personality type. Based on the product or service to be advertised, one of the attitudinal segments will best represent the personality type of the consumer who the advertiser wishes to reach with one or more digital media advertisements.

Next, the attitudinal segments are connected to large databases (e.g., an Experian database which includes information on millions of potential consumers). A large database is selected and each consumer in that database is then ranked against the various attitudinal segment profiles.

Next, the tightest-fitting consumers in a desired segment are identified and selected. Once the desired consumers are selected, a database which includes data associated with cookies residing on specific digital devices 16 is utilized to identify the specific digital devices 16 being used by the selected consumers. There are various services which link cookies to name and address folders.

Then, an advertiser specifies the specific cookies they are looking for (the specific cookies represent the specific consumers they want to reach) to make a media buy. Advertising is bought from digital media providers on a cookie-by-cookie or a consumer-by-consumer basis, allowing marketers to reach exactly the right consumers with exactly the right advertisements. For example, arrangements can be made with Yahoo, AOL, etc. so that whenever a certain cookie appears on a certain digital device 16, a particular digital advertisement will be sent to the IP address associated with the certain digital device 16 and displayed by the certain digital device 16.

For embodiments where the consumers are grouped into segments based on a combination of attitudinal and behavioral data associated with the consumers, the general process is the same as described in paragraphs [0024]-[0027] but the behavioral data is typically obtained from existing databases. In cases where the desired behavioral data available from existing databases is not sufficient, the behavioral data may be obtained from responses to surveys/questionnaires.

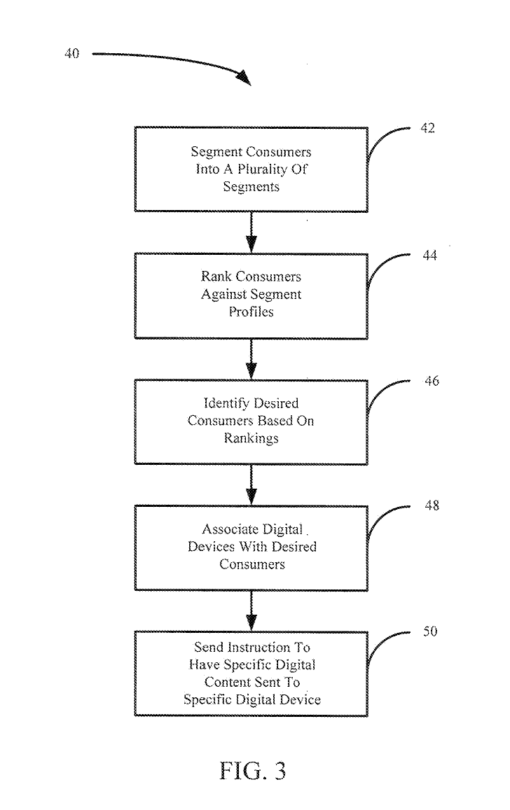

FIG. 3 illustrates various embodiments of a method 40. The method 40 may be implemented by the system 10. The method 40 begins at block 42, where consumers are segmented into any number of distinct segments. The consumers may be segmented based on expressed attitudes. Alternatively, the consumers may be segmented based on a combination of (1) expressed attitudes and (2) past behavior and/or expressed future dispositions to take certain actions.

From block 42, the process advances to block 44, where consumers in a large database are ranked against the profiles associated with the various segments. From block 44, the process advances to block 46, where desired consumers are identified and selected based on the rankings established at block 44. The process described at blocks 42-46 may be performed by aspects of the computing system 10 which are similar or identical to those of targeting engines disclosed in U.S. Pat. Nos. 7,472,072 and 7,835,940, as well as those disclosed in U.S. patent application Ser. Nos. 12/869,441, 13/020,967, 13/167,899 and 13/298,324, each of which are owned by the Assignee of the instant application and the contents of which are hereby incorporated by reference in their entireties.

From block 46, the process advances to block 48, where the cookie pool module 26 utilizes information from a database (e.g., a database associated with the computing system 18) to associate specific digital devices 16 with the selected desired consumers. As explained hereinabove, such a database includes data associated with cookies residing on the specific digital devices 16, and the cookie pool module 26 utilizes the cookie data residing in the database to make the associations between the desired consumers and the digital devices.

From block 48, the process advances to block 50, where the instruction module 28 sends an instruction to the computing system 20 to have specific digital information (e.g., an advertisement) sent to a specific digital device 16 which is associated with a desired consumer. Thereafter, the computing system 20 sends the appropriate advertisement to the digital device 16 for subsequent viewing by the desired consumer. The process described at blocks 42-50 may be repeated any number of times for any number of consumers and any number of cookies and digital devices.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

What is claimed is:

1. A system, comprising:
a computing device, wherein the computing device comprises a processor;
a cookie pool module communicably connected to the processor, wherein the cookie pool module is configured to:
receive cookie pool data; and
utilize the received cookie pool data to associate a targeted consumer with a corresponding digital device; and
an instruction module communicably connected to the processor, wherein the instruction module is configured to send an instruction to have digital information sent to the digital device.

2. The system of claim 1, wherein the digital information is at least one of the following:
an advertisement;
site content; and
a technical capability.

3. The system of claim 1, wherein the system is further configured to identify the targeted consumer.

4. The system of claim 1, wherein the system is further configured to group consumers into a plurality of segments.

5. The system of claim 4, wherein the plurality of segments are attitudinal segments.

6. The system of claim 4, wherein the plurality of segments are a combination of attitudinal and behavioral segments.

7. The system of claim 4, wherein the system is further configured to rank the consumers against each of the segments.

8. A method, implemented at least in part by a computing device, the method comprising:
receiving cookie pool data, wherein the receiving is performed by the computing device;
associating a targeted consumer with a corresponding digital device based on the received cookie pool data, wherein the associating is performed by the computing device; and
sending an instruction to have digital information sent to the digital device, wherein the sending is performed by the computing device.

9. The method of claim 8, wherein sending the instruction to have digital information sent to the digital device comprises sending the instruction to have at least one of the following sent to the digital device:
an advertisement;
site content; and
a technical capability.

10. The method of claim 8, further comprising identifying the targeted consumer.

11. The method of claim 8, further comprising grouping consumers into a plurality of segments.

12. The method of claim 11, wherein grouping the consumers into the plurality of segments comprises grouping the consumers into a plurality of attitudinal segments.

13. The method of claim 11, wherein grouping the consumers into the plurality of segments comprises grouping the consumers into a combination of attitudinal and behavioral segments.

14. The method of claim 11, further comprising ranking the consumers against each of the segments.
